(19) United States
(12) Patent Application Publication
(10) Pub. No.: US 2026/0209048 A1
(43) Pub. Date: Jul. 23, 2026

(54) COATED GRAPHITE PARTICULATE MATERIAL

(71) Applicant: IMERTECH SAS, Paris (FR)

(72) Inventors: Raffaele GILARDI, Bellinzona (CH); Michal GULAS, Malvaglia (CH); Hiroyuki MORIOKA, Kanagawa (JP); Shinya OKABE, Fukuoka (JP); Jérôme CRÉPIN-LEBLOND, Colomiers (FR)

(21) Appl. No.: 19/141,093

(22) PCT Filed: Dec. 20, 2023
(86) PCT No.: PCT/EP2023/087110

§ 371 Date: Jun. 19, 2025

(30) Foreign Application Priority Data
Dec. 20, 2022 (EP) 22306955.0

(51) Int. Cl. C01B 32/21; C08K 3/04; C25B 13/08; H01M 8/1046; H01M 8/18

(52) U.S. Cl. CPC C01B 32/21; C08K 3/04; C25B 13/08; H01M 8/1046; H01M 8/188; C01P 2002/82; C01P 2004/51; C01P 2004/61; C01P 2004/84; C01P 2006/11; C01P 2006/12; C01P 2006/40; C08K 2201/005; C08K 2201/006

(57) ABSTRACT

The present invention relates to novel coated graphite particulate materials comprising graphite particles coated with a layer of amorphous carbon, wherein the coated graphite particulate materials are characterized by a particle size distribution (PSD) with a D₅₀ of at least about 20 μm, a BET specific surface area (BET SSA) of less than about 3.0 m²/g and a crystallographic L_{c} value of at least about 210 nm. The present invention also provides methods for making the coated graphite particulate material, as well as polymer composite compositions comprising said coated graphite particulate materials. The invention further relates to bipolar plates and downstream products such as fuel cells including the bipolar plates which comprise said coated graphite particulate materials.

### FIELD OF THE DISCLOSURE

The present invention relates to novel surface-coated graphite particulate materials comprising graphite particles coated with a layer of amorphous carbon, e.g., pyrolytic carbon, which may have been prepared by suitable coating techniques, such as chemical vapor deposition (CVD). Also described herein are processes for making such a particulate material. Furthermore, uses and downstream products for the novel composite particulate materials are disclosed herein, such as compositions comprising the coated graphite particulate material as a conductive material in polymer composite materials that are useful as, for example, bipolar plates in hydrogen (PEM) fuel cells or redox-flow batteries.

### BACKGROUND

Hydrogen fuel cells are an area of research which has gathered significant interest not only from the scientific community, but also from the general public and the industry. The most common type of hydrogen fuel cell for many important applications (e.g., vehicle applications) is the polymer electrolyte membrane (PEM) fuel cell. In a PEM fuel cell (also known as proton-exchange membrane fuel cell “PEMFC”), an electrolyte membrane is sandwiched between a positive electrode (cathode) and a negative electrode (anode), physically separated but electrically connected to the fuel cell stack by bipolar plates.

Bipolar plates are thus an integral component of PEM hydrogen fuel cells. In order to allow for smooth operation of the hydrogen fuel cell, bipolar plates need to be gastight and display good electric and thermal conductivity, be easily processable and resistant to clamping forces and corrosion during operation. Since the bipolar plates often represent the bulk of a PEM fuel cell, expensive materials can significantly drive up the cost of the PEM fuel cell. As such, low-cost, yet effective materials are highly desirable for the preparation of bipolar plates. Moreover, especially for mobile applications, e.g. in vehicles, low-weight bipolar plates are desired to allow for efficient, lightweight electric vehicles.

Metallic bipolar plates are widely used because of their high electrical and thermal conductivity, high mechanical strength and low cost (in case of stainless steel). In addition, thin plates (<1 mm) can be easily formed with metals, making them attractive for automotive applications. However, metals are prone to corrosion, which is detrimental for the lifetime of the fuel cell. To prevent this corrosion, metal plates require a protective coating (e.g. metal nitride) which adds an additional processing step and increases the cost of metal plates, while leaving the long-term risk of corrosion for applications where 10′000-hours of life-time are required.

A promising alternative to these metal-based bipolar plates are bipolar plates made of polymer composite materials wherein a carbon particulate material is embedded in a polymer matrix (which can be either a thermoplastic or a thermoset polymer). Ideally, polymer-graphite composite-based bipolar plates combine the advantages of good electric conductivity, suitable thermal conductivity, low cost, low weight, and high durability to form bipolar plates with very advantageous properties. Typically, workable loading levels of carbon particulate material in bipolar plates may reach up to 80 or 85 wt. % of graphite within the polymer matrix. However, while such loadings enable good electric conductivity, such polymer composite compositions tend to form highly viscous polymer compositions prior to formation of the bipolar plate, which are difficult to process in an efficient manner.

Carbonaceous particulate materials that have been incorporated into such bipolar plates include synthetic graphite, (purified) natural graphite, expanded graphite, carbon fibers, carbon nanotubes, and/or amorphous graphite powders, such as, e.g., carbon black. Natural and synthetic graphite particles are known in various sizes and morphologies, such as, for example, having more “spherical” (rounded), or more “flaky” shapes. The different carbon and graphite shapes are associated with varying levels of anisotropy due to their three-dimensional orientation, with lower anisotropy for more spherical carbon structures. Isotropic carbon materials are generally thought to be advantageous for graphite-containing bipolar plates in PEM fuel cells, not the least since bipolar plates in fuel cells are normally characterized by lower through-plane conductivity (across the fuel cell stack), especially when flaky particles (or other highly anisotropic materials) are used.

In terms of processing, flowability issues are particularly prevalent for non-spherical particles, for example for plate-like particles, such as non-modified (i.e., “flaky”) natural graphite. Due to their shape and adhesion forces, the particles tend to stick together giving rise to problems with respect to the processing, dosing, and the dispersion of these particles in thermoplastic and thermosetting matrices. Flaky graphite also has low apparent density in comparison to spherical or other non-flaky graphites, which also results in poor flowability.

While attempts have been made to improve the flowability of plate-like graphite particles (such as synthetic or natural flaky graphite), measures such as grinding or converting the particles into spherical graphite typically leads to a significant increase of the electrical and thermal resistivity in the matrices (which can be explained by the change of the particle shape/morphology). S. I. Heo et al., Adv. Comp. Mater., Vol 15, No. 1, (2006) 115-126 and T. Derieth et al., J. of New Mat. for Electr. Syst. 11 (2008) 21-29 can serve to provide the skilled reader further insight into the connection and influence of particle morphology on compounding and molding processes thereof, as well as the electrical and mechanical properties of composite materials formed therefrom.

As mentioned earlier, carbon black is one particulate form of amorphous carbon. The structure of carbon black particles is made up of typically spherical amorphous primary particles which are bound together by covalent bonds to form larger aggregates. However, compared to graphite, the thermal conductivity of amorphous carbon is significantly lower. Conductive carbon black particles typically consist of primary particles of 10-50 nm in size and large, complex particle aggregates that are often more than 100 nm in diameter. The conductive carbon black aggregates form a conductive network in porous electrodes thus decreasing the electronic resistance (J. B. Donnet, R. P. Bansal, M. J. Wang, in Carbon Black Science and Technology, 2nd ed., Marcel Dekker Inc., New York, 1993). The large intra- and inter-aggregate void volume of conductive carbon black created by the carbon black structure results in high oil absorption numbers. Conductive carbon blacks typically have oil absorption numbers above 150 mL/100 g (measured according to ASTM D2414-01, see method described below).

Amorphous coatings of carbon at the surface of graphitic materials are desirable for technical applications utilizing the core properties of crystalline carbon but in which the particle surface with a high degree of graphitization deteriorates some of the application parameters related to the surface properties of the graphitic material, such as a high Braun-Emmett-Teller (BET) solid surface area (SSA). Moreover, amorphous coatings are desirable for technical applications in which the surface chemistry or morphology of the carbonaceous core deteriorates some of the application parameters related to the surface properties of the carbonaceous material.

Amorphous carbon coating can be achieved by several methods known in the art, such as pitch coating and subsequent carbonization at elevated temperatures, or by more modern techniques, such as chemical vapor deposition (CVD). In any event, the amorphous carbon-coated graphitic particles of the present invention are believed to be unique compared to other surface-coated graphite materials described in the literature.

For example, Guoping et al., Solid State Ionics, 176, 2005, pp. 905-909, describe the coating of milled spherical natural graphite by CVD at temperatures of between 900° C. and 1200° C. leading to improved initial coulombic efficiency and better cycle stability for Li-Ion batteries. Natarajan et al., Carbon, 39, 2001, pp. 1409-1413, describe the CVD coating of synthetic graphite at temperatures between 700° C. and 1000° C. The authors report that a CVD coating at around 800° C. yielded the best results in terms of coulombic efficiency (for Li-Ion batteries) while showing a decreased disorder of the treated graphite particles (i.e. the intensity of the D band as determined by Raman spectroscopy decreases compared to the untreated material). Interestingly, the authors report that at 1000° C. the intensity of the D band increased, hinting at an increased disorder on the surface of the graphite particles at the higher temperature. Finally, Ding et al., Surface & Coatings Technology, 200, 2006, pp. 3041-3048, likewise report on CVD coated graphite particles by contacting synthetic graphite with methane at 1000° C. Ding et al. conclude that the graphite particles coated by CVD for 30 minutes at 1000° C. exhibited improved electrochemical properties compared to untreated graphite material.

WO 2013/149807 describes surface-modification processes for synthetic graphitic particles obtainable by either an oxidative treatment or, alternatively, by chemical vapor deposition (CVD) coating, which provides graphite materials having improved surface properties. WO 2016/008951 discloses surface-modified carbonaceous materials such as synthetic graphite, wherein the unmodified carbon precursor is first subjected to an amorphous carbon coating (e.g. by CVD), followed by exposing the coated material to an oxygen-containing atmosphere. This procedure results in surface-modified carbonaceous particles that are more hydrophilic compared to the amorphous carbon-coated particles before the surface oxidation (“activation”).

In light of the above, there is a need for graphite particulate materials that are particularly well-suited for use in bipolar plates. Ideally, such graphite materials, when used in a polymer matrix as is common for bipolar plates, should yield polymer composite compositions that have excellent electrical as well as thermal properties, while maintaining good processability (such as having an acceptable viscosity at the high loads needed, e.g., for bipolar plates). Such graphite materials would allow the manufacture of bipolar plates exhibiting excellent thermal and electric conductivity while remaining lightweight, durable and corrosion resistant.

### SUMMARY OF THE INVENTION

The present inventors have surprisingly found that by carefully optimizing the physicochemical properties of graphite, it was possible to provide graphite particles coated with amorphous carbon with improved properties, in particular in terms of electrical and thermal conductivity, as well as good processability during the manufacturing process for, e.g., bipolar plates.

Bipolar plates comprising the novel coated graphite particulate materials of the present invention inter alia display increased though-plane thermal conductivity and decreased electrical resistivity compared to bipolar plates comprising otherwise identical non-coated particulate material. Additionally, while the viscosity of polymer-graphite particle compositions generally increases with an increasing loading of graphite, it was found that the viscosity of polymer compositions comprising the graphite particles of the present invention remains lower than for other graphite-polymer composite compositions.

Accordingly, in a first aspect, the present invention relates to a coated graphite particulate material comprising graphite particles coated with a layer of amorphous carbon, wherein the coated graphite particulate material is characterized by a particle size distribution (PSD) with a D₅₀ of at least about 20 μm, optionally of at least about 23 μm, or at least about 25 μm, or at least about 27 μm, or at least about 30 μm, or at least about 35 μm, or at least about 40 μm. In this first aspect, the coated graphite particulate material is characterized by a BET specific surface area (BET SSA) of less than about 3.0 m²/g, optionally of less than about 2.8 m²/g, or less than about 2.6 m²/g, or less than about 2.4 m²/g, or less than about 2.2 m²/g. Additionally, in this first aspect the coated graphite particulate material is characterized by a crystallographic L_{c} value of at least about 210 nm, optionally of at least about 250 nm, at least about 300 nm, at least about 400 nm, or at least about 500 nm. Moreover, in this first aspect the coated graphite particulate material is characterized by a Raman I_{D}/I_{G} ratio of at least about 0.25, at least about 0.3, at least about 0.35, at least about 0.4, at least about 0.45, or at least about 0.5.

In another aspect, the present invention provides a method for preparing the coated graphite particulate materials described herein, wherein the method comprises
(i) providing a graphite starting material having a Raman I_{D}/I_{G} ratio of less than about 0.4, optionally of less than about 0.35, or less than about 0.3, or less than about 0.25; a crystallographic L_{c} value of at least about 210 nm, optionally of at least about 250 nm, or at least about 300 nm, or at least about 400 nm, or at least about 500 nm; a particle size distribution (PSD) with a D₅₀ of at least about 20 μm, optionally of at least about 23 μm, at least about 25 μm, at least about 27 μm, at least about 30 μm, at least about 35 μm, or at least about 40 μm; and, optionally, a BET SSA of less than about 5 m²/g, of less than about 4 m²/g, or less than about 3 m²/g, and a tap density of at least about 0.6 g/cm³, or of at least about 0.7 g/cm³ or of at least about 0.8 g/cm³ or of at least about 0.9 g/cm³; and
(ii) coating said graphite starting material with a layer of amorphous carbon, thereby forming the coated graphite particulate material.

In a further aspect of the invention, the invention relates to a coated graphite particulate material obtainable by the method according to the present disclosure.

Yet another aspect of the present invention relates to a composition comprising the coated graphite particulate material and further comprising at least one other carbonaceous particulate material, wherein the at least one other carbonaceous particulate material may optionally be selected from the group consisting of natural graphite, synthetic graphite, expanded graphite, carbon fibers, carbon nanotubes, graphene, coke, carbon black, and mixtures thereof. The at least one other carbonaceous particulate material may typically be present in an amount from 1 wt. % to 80 wt. % based on the total weight of the composition. The composition comprising the coated graphite particulate material may, alternatively or in addition, further comprise at least one metal powder selected from the group consisting of titanium, aluminum, silver, nickel, copper, and mixtures thereof. In such embodiments, the at least one metal powder may optionally be present in an amount of 0.1 wt. % to 10 wt. % based on the total weight of the composition.

In a further aspect, the present invention also relates to a polymer composite material comprising the coated graphite particulate material or a composition comprising the coated graphite particulate material of the present invention embedded in a polymer matrix.

Moreover, the present invention also relates to the use of said coated graphite particulate materials, or of said compositions comprising the coated graphite particulate material, or of said polymer composite material for preparing a bipolar plate, optionally wherein the bipolar plate is suitable for fuel cells, such as proton-exchange membrane (PEM) fuel cells; redox-flow batteries, or water electrolyzers.

In yet another aspect, the present invention also relates to a bipolar plate, which comprises the coated graphite particulate material, or the composition comprising the coated graphite particulate material, or the polymer composite material as described herein. Typically, the bipolar plate is suitable for fuel cells, such as proton-exchange membrane (PEM) fuel cells, redox-flow batteries, or water electrolyzers, such as proton-exchange membrane (PEM) electrolyzers.

In a further aspect, the present disclosure relates to a method for making the bipolar plates comprising
(i) mixing the coated graphite particulate material, or the composition comprising the coated graphite particulate material as described herein with a polymer to form the polymer composite material, and
(ii) forming a bipolar plate with the polymer composite material obtained in the first step. Suitable polymers may include thermoplastic polymers or thermoset polymers, or elastomers. In some embodiments, the mixing is carried out in an extruder. In some embodiments, the bipolar plate is prepared by compression molding, injection molding, or extrusion of the polymer composite material obtained the first step, or by a roll-to-roll process.

In a different aspect, the present invention also relates to the use of said bipolar plates for preparing a fuel cell, such as a proton-exchange membrane (PEM) fuel cell, or a redox-flow battery, or a water electrolyzer, such as a proton-exchange membrane (PEM) electrolyzer.

Finally, the present invention relates to a fuel cell, such as a proton-exchange membrane (PEM) fuel cell, a redox-flow battery, or a water electrolyzer, such as a proton-exchange membrane (PEM) electrolyzer, comprising said bipolar plates as described herein.

### BRIEF DESCRIPTION OF THE DRAWINGS

The present disclosure will be more readily appreciated by reference to the following detailed description when being considered in connection with the accompanying drawings:

FIG. 1 depicts an SEM image of a synthetic graphite, trade name TIMREX® KS 5-75 TT, and available from Imerys Graphite & Carbon (Comparative Example (“CE”) 1, left), a “potato-shaped” natural graphite before CVD coating (Comparative Example 5, middle), and of a CVD coated spherical graphite (Comparative Example 8, right).

FIG. 2 shows the D₅₀ values in microns of the graphite particulate materials used in the examples.

FIG. 3 shows the BET SSA values in m²/g of the graphite particulate materials used in the examples demonstrating that coated graphite particulate material according to the invention exhibited lower BET SSA than comparable uncoated graphite particulate material.

FIG. 4 depicts the L_{c} value in nm for the graphite particulate materials used in the examples.

FIG. 5 depicts the ratio of the I_{D} and I_{G} peak of Raman spectra for the graphite particulate materials used in the examples. In general, I_{D}/I_{G} increases after coating.

FIG. 6 depicts the water contact angle in degrees for the graphite particulate materials used in the examples. In general, hydrophobicity increased after coating.

FIG. 7 depicts the surface energy in mJ/m² for graphite particulate materials used in the examples. In general, surface energy decreased after coating.

FIG. 8 shows the angle of repose of the graphite particulate materials used in the examples (not measured for CE-4). The graphite particulate materials according to the invention show lower angle of repose (i.e. better flowability) compared to comparative graphite particulate materials.

FIG. 9 plots the melt flow index (MFI) of coated and uncoated graphite particulate materials used in the examples at 80 wt. % loading in polypropylene. The coated graphite particles according to the invention display both improved flowability as powders and better processability as polymer composite compositions.

FIG. 10 plots the Torque in Nm for different polymer compositions comprising coated and uncoated, synthetic and natural graphite particulate materials in 80 wt. % loading with polypropylene.

FIG. 11 displays the in-plane electrical resistivity in Q*cm for different plates comprising coated and uncoated, synthetic and natural graphite particulate materials at 80 wt. % loading in polypropylene. Overall, plates made with coated particles showed a lower electrical resistivity than plates comprising their uncoated counterparts.

FIG. 12 displays the through-plane electrical resistivity in (2*cm for 8 different plates comprising coated and uncoated, synthetic and natural graphite particulate materials used in the examples at 80 wt. % loading in polypropylene. Overall, plates made with coated particles showed a lower electrical resistivity than plates comprising their uncoated counterparts.

FIG. 13 displays the in-plane thermal conductivity in W/m*K for different plates comprising coated and uncoated, synthetic and natural graphite particulate materials used in the examples at 80 wt. % loading in polypropylene.

FIG. 14 displays the through-plane thermal conductivity in W/m*K for different plates comprising coated and uncoated, synthetic and natural graphite particulate materials used in the examples at 80 wt. % loading in polypropylene.

FIG. 15 plots the areal specific electrical resistance in mΩ*cm² for compressed plates containing coated particles according to the present disclosure compared to the respective uncoated graphite particulate material. The areal specific resistance was greatly reduced with increased amount of coating.

FIG. 16 shows the melt flow index (MFI) of coated and uncoated graphite particulate materials at both 50 wt. % and 60 wt. % loading in polypropylene. The coated graphite particles according to the invention display improved flowability as powders and better processability as polymer composite compositions.

FIG. 17 displays the in-plane electrical resistivity in Q*cm for different plates comprising coated and uncoated, synthetic and natural graphite particulate materials at 50 wt. % and 60 wt. % loading in polypropylene. Overall, plates made with coated particles showed a lower electrical resistivity than plates comprising their uncoated counterparts and IE 3 shows lowest values and greatly improved electrical conductivity.

FIG. 18 displays the through-plane electrical resistivity in (2*cm for different plates comprising coated and uncoated, synthetic and natural graphite particulate materials at 50 wt. % and 60 wt. % loading in polypropylene. Overall, plates made with coated particles showed a lower electrical resistivity than plates comprising their uncoated counterparts and IE 3 shows lowest values and greatly improved electrical conductivity.

FIG. 19 shows the powder resistivity in mΩ*cm for different coated and uncoated, synthetic and natural graphite particulate materials at pressures of 10 kN/cm² and 20 kN/cm², respectively.

### DETAILED DESCRIPTION

The present inventors have surprisingly found that the coating of highly crystalline graphite particles, in particular flaky or shaped/rounded particles having a suitable particle size distribution, with a BET SSA of less than about 5 m²/g, or less than about 4 m²/g, or less than about 3 m²/g, or of between about 1.2 m²/g to about 3.5 m²/g with a layer of non-graphitic (typically amorphous) carbon leads to a coated graphite particulate material with excellent properties and typically a lower BET SSA, making them particularly useful as a component in polymer-graphite composite compositions. Especially for bipolar plate applications, it was found that natural graphite materials being more isotropic (i.e., shaped/rounded instead of flakey) yield excellent results in terms of electrical and thermal conductivity as well as processability after coating. The polymer composite compositions comprising the coated graphite particulate materials of the present invention are especially useful as a component in bipolar plates (which are, for example, used in polymer electrolyte membrane (PEM) fuel cells), allowing the manufacture of bipolar plates with reduced weight and relatively low manufacturing costs, in particular for PEM fuel cells and the like. Bipolar plates comprising the coated graphite particulate material according to the present invention display improved electrical resistivity over plates comprising comparable spherical particles, while still maintaining good processability during manufacture.

The term “about”, when used herein in the context of parameters or values mentioned herein, encompasses deviations of +10% of the given value, unless stated otherwise.

### Coated Graphite Particulate Material of the Present Disclosure

As noted above, the present invention relates, in a first aspect, to a coated graphite particulate material comprising graphite particles coated with a layer of amorphous carbon, wherein the coated graphite particulate material is characterized by
(i) a particle size distribution (PSD) with a D₅₀ of at least about 20 μm;
(ii) a BET specific surface area (BET SSA) of less than about 3.0 m²/g;
(iii) a crystallographic L_{c} value of at least about 210 nm (wherein, for the crystallographic L_{c}-value “about” encompasses deviations of +5% of the given value); and
(iv) a Raman I_{D}/I_{G} ratio of at least about 0.25, at least about 0.3, at least about 0.35, at least about 0.4, at least about 0.45, or at least about 0.5.

In some embodiments, the coated graphite particulate material is characterized by a particle size distribution (PSD) with a D₅₀ of at least about 23 μm, or at least about 25 μm, or at least about 27 μm, or at least about 30 μm, or at least about 35 μm, or at least about 40 μm, or between about 20 μm and about 60 μm.

In some embodiments, the coated graphite particulate material is characterized by a BET SSA of less than about 2.8 m²/g, or less than about 2.6 m²/g, or less than about 2.4 m²/g, or less than about 2.2 m²/g, or of between about 1.2 m²/g and about 3.0 m²/g.

In some embodiments, the coated graphite particulate material is characterized by a crystallographic L_{c} value of at least about 250 nm, at least about 300 nm, at least about 400 nm, or at least about 500 nm, or of between about 210 nm and about 800 nm.

In certain embodiments, the coated graphite particulate material may further be characterized by a tap density of at least about 0.7 g/cm³, least about 0.8 g/cm³, or at least about 0.9 g/cm³. In some embodiments, the tap density may be between about 0.7 g/cm³ and about 1.4 g/cm³.

In some embodiments, the coated graphite particulate material may be further characterized by a xylene density of at least about 2.22 g/cm³, or at least about 2.23 g/cm³. In some embodiments the xylene density may be between about 2.22 g/cm³ and about 2.26 g/cm³.

In some embodiments, the Raman I_{D}/I_{G} ratio for the coated graphite particulate material may be between about 0.25 and about 0.75.

Since the laser used in Raman spectroscopy cannot cross the graphite particles, Raman represents a spectroscopy method that is particularly useful for characterizing the surface properties of a particulate material (here graphitic particles). Thus, in general, the Raman R (I_{D}/I_{G}) value is on the one hand dependent on the properties of the starting natural graphite material (and especially its surface properties) before the coating, and on the other hand on the properties and thickness of the coating with non-graphitic (e.g. amorphous) carbon, as the amorphous carbon on the surface increases the intensity of the D band over the G band (compared to graphitic carbon).

Alternatively or in addition, the crystallographic c/2 value of the coated graphite particulate material may in certain embodiments be less than about 0.3360 nm, less than about 0.3358 nm, or less than about 0.3356 nm. In some embodiments the crystallographic c/2 value may be between about 0.3346 nm and about 0.3360 nm.

In some embodiments, the coated graphite particulate material may be further characterized by a particle size distribution (PSD) having a D₁₀ of at least about 10 μm, at least about 12 μm, at least about 15 μm, or at least about 20 μm. Moreover, in the same or different embodiments the coated graphite particulate material may be further characterized by a particle size distribution (PSD) with a D₉₀ of at least about 30 μm, at least about 40 μm, at least about 50 μm, at least about 55 μm, at least about 60 μm, at least about 70 μm, or at least about 80 μm. In some embodiments the particle size distribution (PSD) of the coated graphite particulate material may be characterized by a D₁₀ of between about 10 μm and about 30 μm and/or a D₉₀ of between about 30 μm and about 100 μm.

The coated graphite particulate material may optionally be further characterized by one or more of the following parameters.

In certain embodiments, the coated graphite particulate material may have a spring-back value of less than about 50%, less than about 45%, less than about 40%, less than about 35%, or less than about 30%. In some embodiments, the spring-back value may be between about 10% and about 35%.

In some embodiments, the angle of repose of the coated graphite particulate material may be less than about 40°, less than about 38°, or less than about 36°. In some embodiments the angle of repose of the coated graphite particulate material may be between about 30° and about 40°.

The water contact angle of the coated graphite particulate material may in certain embodiments be at least about 70°, at least about 80°, or at least about 85°. In some embodiments, the water contact angle may be between about 70° and about a 110°.

In certain embodiments, the disperse surface energy of the coated graphite particulate material is less than about 40 mJ/m², or less than about 35 mJ/m², or less than about 30 mJ/m². In some embodiments, the disperse surface energy may be between about 15 mJ/m² and about 40 mJ/m².

The coated graphite particulate material of some embodiments may be further characterized by a polar surface energy of less than about 10 mJ/m², or less than about 8 mJ/m², or less than about 6 mJ/m². In some embodiments, the polar surface energy may be between about 2 mJ/m² and about 10 mJ/m².

Additionally or alternatively, in some embodiments the coated graphite particulate material may be further characterized by a total surface free energy of less than about 40 mJ/m², or less than about 34.6 mJ/m², or less than about 31 mJ/m². In some embodiments, the total surface free energy may be between about 26 mJ/m² and 34.6 mJ/m².

In some embodiments, the coated graphite particulate material may be further characterized by a powder electrical resistivity of less than about 8 m²²*cm, or less than about 7 m²²*cm at 10 kN/cm². Alternatively or in addition, the coated graphite particulate material may also be further characterized by a powder electrical resistivity of less than about 6 m²²*cm, or less than about 5 mΩ*cm at 20 kN/cm².

The initial graphite particles to be coated in accordance with the methods described herein (“base graphite particles”) can typically be any natural or synthetic graphite that is generally suitable for use as a conductive material in bipolar plates. The base particles can be characterized by any morphology, e.g., being plate-like (flaky), “potato-shaped”, rod-like, or (next to) spherical, provided the particle size distribution (PSD) of the base particles is having a D₅₀ of at least about 20 μm. The preferred morphology for the base particles is “shaped” or spherical, which have a higher tap density which is beneficial when subjected to a CVD process and also for the flowability of the powder in the application (e.g. easy feeding into an extruder).

In general, the base graphite particles to be coated, in particular for applications such as conductive material in polymer composite-based bipolar plates, should be characterized, apart from a suitable minimum size (e.g., having a D₅₀ of more than about 20 μm) by a relatively high crystallinity, as for example expressed by a relatively high crystallographic L_{c} value and low c/2 values (above 210 nm and below 0.3360 nm, respectively). It will be understood by one of skill in the art that the coating does not significantly affect these values. Typically, the coating will slightly increase the size of the particles and may slightly decrease crystallinity and c/2 values due to the contribution of the amorphous carbon surface.

In some embodiments, the base graphite particles are natural graphite (i.e., flaky or shaped/rounded) having a suitable PSD as outlined above. Especially for bipolar plate applications, it was found that natural graphite materials being more isotropic (i.e., shaped/rounded) yield excellent results in terms of electrical and thermal conductivity as well as processability.

The coating of the coated graphite particulate material according to the present invention is an amorphous carbon coating. Amorphous carbon coatings of carbonaceous particles are generally known in the art. In some embodiments, the amorphous carbon coating may be a pyrolytic carbon coating, wherein the layer of amorphous carbon coating is, for example, obtained by chemical vapor deposition (CVD), plasma-enhanced chemical vapor deposition (PECVD), atomic layer deposition (ALD), or physical vapor deposition (PVD).

Amorphous carbon coatings may also be obtained by (coal tar) pitch coating, wet coating or spray drying followed by carbonization, hydrothermal carbonization, or sol-gel processes.

In some preferred embodiments of the present invention, the pyrolytic surface coating of the graphite particulate material can be achieved by chemical vapor deposition (CVD). In the case of carbon compounds such as graphite, the CVD process evenly coats the surface of graphite particles with mostly disordered (e.g. amorphous) carbon-containing particles. Generally, coated graphite particulate materials characterized by the parameters given are obtainable by contacting the base graphite particles by chemical vapor deposition at temperatures ranging from about 500° C. to about 1000° C. with a hydrocarbon-containing gas or alcohol vapor mixed with an inert carrier gas for treatment times ranging from 3 to 120 minutes in a suitable furnace, as will be described in more detail below when discussing the processes for making the coated graphite particulate materials of the present invention.

In certain embodiments, the layer of amorphous carbon may be present in the coated graphite particulate material in an amount of more than about 1 wt. %, or more than about 2 wt. %, or between about 1 wt. % and about 15 wt. %, or between about 1 wt. % and about 10 wt. %, or between about 1 wt. % and about 6 wt. %, or between about 1 wt. % and about 5 wt. %, or between about 2 wt. % and about 10 wt. %, or between about 3 wt. % and about 8 wt. %, or between about 3 wt. % and about 7 wt. %, or between about 3 wt. % and about 6 wt. %, based on the total weight of the coated graphite particulate material.

### Process for Preparing the Coated Graphite Particulate Materials of the Present Invention

Another aspect of the present invention relates to a process for making the coated graphite particulate materials according to the present invention. The process comprises, in its most general form:
(i) providing a graphite starting material having a Raman I_{D}/I_{G} ratio of less than about 0.4, or less than about 0.35, or less than about 0.3, or less than about 0.25, or between about 0.20 and about 0.40, a crystallographic L_{c} value of at least about 210 nm, or at least about 250 nm, or at least about 300 nm, or at least about 400 nm, or at about least 500 nm, or between about 250 nm and about 800 nm, a particle size distribution (PSD) with a D₅₀ of at least about 20 μm, or at least about 23 μm, or at least about 25 μm, or at least about 27 μm, or at least about 30 μm, or at least about 35 μm, or at least about 40 μm, or between about 25 μm to about 60 μm, a tap density of at least about 0.6 g/cm³, or of at least about 0.7 g/cm³ or of at least about 0.8 g/cm³ or of at least about 0.9 g/cm³; and
(ii) coating of the graphite starting material with a layer of amorphous carbon, thereby forming the coated graphite particulate material according to the present disclosure.

In some embodiments, the graphite starting material has a BET SSA of less than about 5 m²/g, or less than about 4 m²/g, or less than about 3 m²/g, or of between about 1.2 m²/g to about 3.5 m²/g. As explained earlier, the BET SSA of the coated graphite particulate material is typically (but not always) lower than the BET SSA of the graphite starting material. Thus, depending on the details of the coating process used, it will be understood that suitable starting graphite particles should have a BET SSA which is close to the desired BET SSA of the coated product (but may typically be a bit higher than the desired BET SSA of the coated product). Typically, the graphite starting material is uncoated and coated by the process for preparing the coated graphite particulate materials of the present invention. However, in some embodiments, the graphite starting material may also be a coated graphite material characterized by the parameters set out in the preceding paragraph, that is subsequently further coated by the process described herein. In some embodiments, the graphite starting material is a coated graphite particulate material according to the invention, i.e., a coated graphite particulate material that is characterized by parameters fulfilling the parameter ranges of both, the starting material (set out in the preceding paragraph), and the parameters set out for the final product as defined herein. The multi-coated graphite particulate material obtained by said embodiments of the process may possess certain beneficial properties imbued by said additional coating step, which may outweigh the additional expense and effort associated with the additional coating.

In some embodiments, the layer of amorphous carbon to be deposited on the graphite starting material by the coating step can be obtained by a method selected from chemical vapor deposition (CVD), plasma-enhanced chemical vapor deposition (PECVD), atomic layer deposition (ALD), or physical vapor deposition (PVD) of pyrolytic carbon.

In other embodiments, the amorphous carbon layer can be obtained by (coal tar) pitch coating, wet coating followed by carbonization, spray drying followed by carbonization, hydrothermal carbonization, or sol-gel processes.

In some preferred embodiments of the present invention, the surface coating of the graphite particulate material in coating step (ii) of the process can be preferably achieved by chemical vapor deposition (CVD) of pyrolytic carbon on the graphite starting material.

The chemical vapor deposition (CVD) step is in certain embodiments carried out by contacting the graphite particulate material to be coated with a hydrocarbon gas or alcohol vapor mixed with an inert carrier gas. The hydrocarbon gas is preferably chosen from an aliphatic or aromatic hydrocarbon selected from the group consisting of methane, ethane, ethylene, propane, propene, acetylene, butane, isobutene, benzene, toluene, xylene, liquefied petroleum gas (LPG), natural gas, and combinations thereof. Particularly preferred hydrocarbon gases are acetylene, natural gas, methane or propane. The alcohol used in the CVD coating step (ii) is in some embodiments preferably selected from the group consisting of ethanol, propanol, isopropanol, and combinations thereof, with ethanol or propanol being particularly preferred. The hydrocarbon gas or alcohol vapor may also be mixed with an inert carrier gas such as nitrogen or argon, preferably nitrogen.

Suitable gas flow rates for the CVD coating are generally dependent on the particular circumstances (reactor type, load, residence time, and type of starting material), and can be determined by those of skill in the art using the information contained herein. In some embodiments, good results were obtained with propane or acetylene gas with a flow rate of around 1 to 5 L/min, of around 1 to 3 L/min, or of around 1 to 2 L/min, optionally in combination with an inert carrier gas with a flow rate of around 1 to 10 L/min, of around 1 to 8 L/min, of around 2 to 5 L/min, or 2 to 3 L/min although the exact flow rate depends on the reactor type, material to be treated and other process parameters. In other embodiments, a pre-prepared mixture of propane or acetylene gas with nitrogen or argon carrier gas can be used for the CVD coating step. For example, in a fluidized bed reactor the coating is achieved with higher flow rates, for example with a flow rate of around 1 to 50 L/min, 10 to 25 L/min, or 20 to 25 L/min. In some embodiments, the ratio of the propane or acetylene gas to the inert carrier gas in the mixture is about 1:10 or 1:9.

In case of liquid hydrocarbons (benzene, toluene, isopropanol, ethanol, etc.) hydrocarbon flows of 0.1 g/min up to 10 g/min are used to provide a coating for about 0.1 kg to about 15 kg of raw material depending on the size of the equipment.

The CVD coating step according to certain embodiments of this aspect of the present invention is typically carried out with residence times in the reactor ranging from 10 to 180 minutes, 10 to 120 minutes, 10 to 60 minutes, or 20 to 40 minutes. In other words, the contacting period between the graphite starting material and the hydrocarbon gas or alcohol vapors for achieving the CVD coating is usually from 10 to 180 minutes, or from 10 to 120 minutes, from 10 to 60 minutes, or from 20 to 40 minutes.

It will be readily apparent to one of skill in the art that the treatment time must of course be adjusted to be long enough for depositing the desired amount of amorphous carbon onto the graphite particles.

The temperatures for the CVD coating step will typically range from 500° C. to 1200° C., although in many cases, the temperature will typically range from 600° C. to 1100° C., or from 700° C. to 1050° C.

The CVD coating step is generally carried out at a slight overpressure. Thus, in certain embodiments, the CVD coating step is carried out at a pressure of 0 to 80 mbar, 0 to 60 mbar, 0 to 50 mbar, 10 to 60 mbar, 10 to 50 mbar, or 0 to 40 mbar above atmospheric pressure. Hence, in certain embodiments, the CVD coating step will comprise a temperature range from 500° C. to 1200° C. in a reactor, optionally from 600° C. to 1100° C. or from 700° C. to 1050° C., a constant flow of an inert carrier gas such as nitrogen fed to the reactor in a flow rate of around 1 to 10 L/min, and a hydrocarbon fed to the reactor in a flow rate of 1 to 5 L/min in case the hydrocarbon is a gas or a flows of 0.1 g/min up to 10 g/min in case the hydrocarbon is a liquid. In some embodiments, the hydrocarbon is acetylene, natural gas, methane or propane, or mixtures thereof, or benzene or toluene, or a mixture thereof. In some embodiments, the CVD coating step may proceed at a slight overpressure of 0 to 80 mbar and for a residence time in the reactor typically ranging from 10 to 180 minutes. In embodiments where the reactor is a fluidized bed reactor, the CVD coating may also be achieved with higher overall flow rates (i.e., a combination of inert and hydrogen gas flow), for example with an overall flow rate of around 1 to 50 L/min. In some embodiments of the CVD coating step described herein, a vertical electrically heated fluidized bed reactor may be used. Alternatively, in other embodiments of the CVD coating step described herein, the reactor is a rotary kiln reactor used in a continuous production setup. In certain embodiments of said continuous reactor setup, the rotary kiln reactor may be about 2 m long, set up at an inclination of 3-4° and a rotation of 6-8 rpm.

Having regard to the process of the invention as described herein, another aspect of the present invention relates to coated graphite particulate materials characterized by the parameters described above, which are obtainable by a process as described herein.

### Compositions Comprising the Coated Graphite Particulate Material of the Present Invention

In yet another aspect, the present invention relates to a composition comprising the coated graphite particulate material according to the present invention, and further comprising at least one other carbonaceous particulate material.

In some embodiments, the at least one other carbonaceous particulate material is selected from the group consisting of natural graphite, synthetic graphite, expanded graphite, carbon fibers, carbon nanotubes, graphene, coke, carbon black, and combinations thereof.

In some embodiments, the at least one other carbonaceous particulate material is present in an amount of between 1 to 80 wt. %, 1 to 70 wt. %, 1 to 60 wt. %, 1 to 50 wt. %, 1 to 40 wt. %, 1 to 30 wt. %, or 1 to 20 wt. %, based on the total weight of the composition.

In some embodiments, the composition comprising the coated graphite particulate material according to the present invention further comprises, alternatively or in addition to the other carbonaceous particulate materials described above, at least one metal powder selected from the group consisting of titanium, aluminum, silver, nickel, copper, and mixtures thereof. In some embodiments, the at least one metal powder is present in an amount of 0.1 wt. % to 10 wt. % based on the total weight of the composition.

### Polymer Composite Materials Comprising the Coated Graphite Particulate Material of the Present Invention

In an additional aspect, the present invention relates to a polymer composite material comprising the coated graphite particulate material according to the present invention (or the composition comprising the coated graphite particulate material and at least one other carbonaceous particulate material and or at least one metal as described above), and a polymer. In these embodiments, the coated graphite particles are typically distributed, preferably homogenously, within a polymer matrix.

In some embodiments of this aspect of the present invention, the polymer is present in an amount of between 5 wt. % to 55 wt. %, 6 wt. % to 50 wt. %, 7 wt. % to 45 wt. %, 8 wt. % to 40 wt. %, or 9 wt. % to 35 wt. %, preferably wherein the polymer is present in an amount of between 10 wt. % and 30 wt. % based on the total weight of the polymer composite material.

In certain embodiments, the polymer is selected from a thermoplastic polymer, a thermoset polymer, an elastomer or mixtures/blends of such polymers (or polymers modified with other polymers). Suitable polymers include for example polypropylene (PP), polyphenyl sulfide (PPS), fluorinated ethylene propylene (FEP) or polyvinyldifluoride (PVDF). Suitable thermoset polymers include epoxy resins, phenolic resins, or an ethylene octene copolymer. Examples of suitable elastomers include synthetic or natural rubber.

In some embodiments of this aspect of the present invention, the amount of the coated graphite particulate material or the composition comprising said coated graphite particulate material as described herein ranges from 45 wt. % to 95 wt. %, or 50 wt. % to 94 wt. %, or 55 wt. % to 93 wt. %, or 60 wt. % to 92 wt. %, or 65 wt. % to 91 wt. %, based on the total weight of the polymer composite material. In some preferred embodiments, the graphite particulate material or the composition comprising said coated graphite particulate material is present in an amount of between 70 wt. % and 90 wt. % based on the total weight of the polymer composite material.

In some embodiments, the polymer composite material may further comprise one or more of the following materials: expanded graphite, natural graphite, synthetic graphite, carbon fibers, carbon nanotubes, graphene, coke, carbon black, and metal powders, such as titanium, aluminum, silver, nickel, copper, or mixtures thereof. In embodiments where a metal powder is included in the polymer composite material, the at least one metal powder is preferably present in an amount of 0.1 wt. % to 10 wt. % based on the total weight of the polymer composite material.

Downstream Products and Uses as Well as Methods of Making these Products

Another aspect of the present invention relates to uses of the coated graphite particulate material, the graphite comprising composition, or the polymer composition according to the present invention for preparing a bipolar plate.

In some embodiments of this aspect of the present invention, the bipolar plate is suitable for use in fuel cells, in particular, in proton-exchange membrane (PEM) fuel cells, or in redox-flow batteries, or in water electrolyzers, such as proton-exchange membrane (PEM) electrolyzers.

While the coated graphite particulate material, or compositions comprising it, are especially useful when used as an conductive material in bipolar plates, it will be understood that the coated graphite particulate material may also be suitable for other applications where an electrically and thermally conducting, low-weight, low-cost and chemically inert component is needed; such as, i.e., conductive polymers for EMI shielding.

In a related aspect, the present invention further relates to bipolar plates comprising the coated graphite particulate materials, the compositions comprising said coated graphite particulate materials, or the polymer composite compositions as described herein. In some embodiments, the bipolar plate is suitable for use in fuel cells, such as proton-exchange membrane (PEM) fuel cells, in redox-flow batteries, or in water electrolyzers, such as proton-exchange membrane (PEM) electrolyzers.

Yet another aspect of the present invention relates to a method for making a bipolar plate as described herein, comprising, in a first step, mixing a coated graphite particulate material or a composition comprising said coated graphite particulate material as described herein, with a polymer to form a polymer composite material as described. The second step of the method comprises forming a bipolar plate with the polymer composite material obtained from the mixing step.

In some embodiments of this aspect, the polymer to be mixed with the coated graphite particulate material, or the composition comprising it, is selected from a thermoplastic polymer, a thermoset polymer, an elastomer or mixtures/blends of such polymers (or polymers modified with other polymers). Suitable polymers include for example polypropylene (PP), polyphenyl sulfide (PPS), fluorinated ethylene propylene (FEP), or polyvinyldifluoride (PVDF). Suitable thermoset polymers include epoxy resins, phenolic resins, or an ethylene octene copolymer. Examples of suitable elastomers include synthetic or natural rubber.

The mixing of the coated graphite particulate material or the graphite comprising it with the polymer is in some embodiments carried out in an extruder. In some embodiments of the present disclosure the second step of forming the bipolar plate may be achieved by techniques generally well-known in the art, such as extrusion of the polymer composite material obtained in the mixing step, or by compression molding or injection molding, or by a so-called “roll-to-roll” process.

In an additional, but related aspect, the present invention relates to the use of a bipolar plate as described above for preparing a fuel cell, a redox-flow battery, or a water electrolyzer. In some embodiments, the fuel cell is preferably a proton-exchange membrane (PEM) fuel cell, while in other embodiments, the water electrolyzer is preferably a proton-exchange membrane (PEM) electrolyzer.

Finally, the present disclosure relates to a fuel cell, preferably a proton-exchange membrane (PEM) fuel cell, a redox-flow battery, or a water electrolyzers, preferably a proton-exchange membrane (PEM) electrolyzers, comprising the bipolar plate according to the present disclosure.

It will be obvious for a person skilled in the art that the above-described embodiments, as well as the working examples described below, only represent examples for a plurality of possibilities, especially in terms of combination of features. Hence, the embodiments described herein should not be understood to limit the present invention, the scope of which is defined in the appended claims.

### Measurement Methods

Suitable methods for determining the various properties and parameters used to define the coated graphite particulate materials and compositions/downstream products comprising them, are set out in more detail below.

The percentage (%) values specified herein are by weight, unless specified otherwise.

### Specific BET Solid Surface Area, DFT Micropore and Mesopore Volume and Area

The method is based on the registration of the absorption isotherm of liquid nitrogen in the range p/p₀=0.04-0.26, at 77 K. The nitrogen gas adsorption was performed on a Quantachrome Autosorb-1. Following the procedure proposed by Brunauer, Emmet and Teller (Adsorption of Gases in Multi-molecular Layers, J. Am. Chem. Soc., 1938, 60, 309-319), the monolayer capacity can be determined. On the basis of the cross-sectional area of the nitrogen molecule, the monolayer capacity and the weight of sample, the specific surface can then be calculated. The isotherm measured in the pressure range p/p₀ 0.01-1, at 77 K may be processed with DFT calculation in order to assess the pore size distribution, micro- and mesopore volume and area.
References: Ravikovitch, P., Vishnyakov, A., Russo, R., Neinark, A., Langmuir, 16, 2000, 2311-2320, Jagiello, J., Thommes, M., Carbon, 42, 2004, 1227-1232.

### Particle Size Distribution (PSD) by Laser Diffraction

The presence of particles within a coherent light beam causes diffraction. The dimensions of the diffraction pattern are correlated with the particle size. A parallel beam from a low-power laser lights up a cell which contains the sample. The beam leaving the cell is focused by an optical system. The distribution of the light energy in the focal plane of the system is then analyzed. The electrical signals provided by the optical detectors are transformed into the particle size distribution by means of a calculator. The method yields the proportion of the total volume of particles to a discrete number of size classes forming a volumetric particle size distribution (PSD). The particle size distribution is typically defined by the values D₁₀, D₅₀ and D₉₀, wherein 10 percent (by volume) of the particle population has a size below the D₁₀ value, 50 percent (by volume) of the particle population has a size below the D₅₀ value and 90 percent (by volume) of the particle population has a size below the D₉₀ value.

The Particle Size Distribution (PSD) for products ranging up to 150 μm is measured by means of the LASER Diffraction according to ISO 13320 and using a Sympatec Helos dry system (without water). A laser beam lights up the measuring chamber in which the graphite sample is blown by means of compressed air, the generated diffraction pattern is collected by means of a Fourier optic system and interpreted using standard models of the light scattering theory, such as that developed by Mie. (see, e.g. Wriedt, T. (2012), Mie Theory: A Review. In: Hergert, W., Wriedt, T. (Eds.) The Mie Theory. Springer Series in Optical Sciences, vol 169. Springer, Berlin, Heidelberg. https://doi.org/10.1007/978-3-642-28738-1_2). The particle size distribution is calculated and reported in μm for the three quantiles: 10% (D₁₀), 50% (D₅₀) and 90% (D₉₀).

### X-Ray Diffraction

XRD data were collected using a PANalytical X'Pert PRO diffractometer coupled with a PANalytical X'Celerator detector. The diffractometer has following characteristics shown in Table 1:

TABLE 1
Instrument data and measurement parameters

| | |
|---|---|
| Instrument | PANalytical X′Pert PRO |
| X-Ray detector | PANalytical X′Celerator |
| X-ray source | Cu-K_{α} |
| Generator parameters | 45 kV-40 mA |
| Scan speed | 0.07°/s |
| Divergence slit | 1° |
| Sample spinning | 60 rpm |

The data were analyzed using the PANalytical X'Pert HighScore Plus software.

### Interlayer Spacing c/2

The interlayer spacing c/2 was determined by X-ray diffractometry. The angular position of the peak maximum of the [002] reflection profiles were determined and, by applying the Bragg equation, the interlayer spacing was calculated (Klug and Alexander, x-ray diffraction Procedures, John Wiley & Sons Inc., New York, London (1967)). To avoid problems due to the low absorption coefficient of carbon, the instrument alignment and non-planarity of the sample, an internal standard, silicon powder, was added to the sample and the graphite peak position was recalculated on the basis of the position of the silicon peak. The graphite sample was mixed with the silicon standard powder by adding a mixture of polyglycol and ethanol. The obtained slurry was subsequently applied on a glass plate by means of a blade with 150 μm spacing and dried.

### Crystallite Size L_{c}

Crystallite size was determined by analysis of the diffraction profile and determining the widths of the peak profiles at the half maximum. The broadening of the peak should be affected by crystallite size as proposed by Scherrer (P. Scherrer, Göttinger Nachrichten, 2, 98, 1918). However, the broadening is also affected by other factors such X-ray absorption, Lorentz polarization and the atomic scattering factor. Several methods have been proposed to take these effects into account by using an internal silicon standard and applying a correction function to the Scherrer equation. For the present disclosure, the method suggested by Iwashita (N. Iwashita, C. Rae Park, H. Fujimoto, M. Shiraishi and M. Inagaki, Carbon, 42, 2004, 701-714) was used. The sample preparation was the same as for the c/2 determination described above.

### Xylene Density

The analysis is based on the principle of liquid exclusion as defined in DIN 51 901. Approx. 2.5 g (accuracy 0.1 mg) of powder was weighed in a 25 ml pycnometer. Xylene was added under vacuum (15 Torr). After a few hours dwell time under normal pressure, the pycnometer was conditioned and weighed. The density represents the ratio of mass and volume. The mass is given by the weight of the sample and the volume is calculated from the difference in weight of the xylene filled pycnometer with and without sample powder.
Reference: DIN 51 901

### Tapped Density

100 g of dry graphite powder was carefully poured into a graduated cylinder. Subsequently, the cylinder was fixed on the off-center shaft-based tapping machine and 400 strokes were run. The reading of the volume was taken and the resulting density calculated.
Reference: DIN-ISO 787-11

### Raman Spectroscopy

Raman analyses were performed using LabRAM-ARAMIS Micro-Raman Spectrometer from HORIBA Scientific with a 632.8 nm HeNe LASER.

The I_{D}/I_{G} ratio (“R value”) is based on the ratio of intensities of the so-called band D and band G. These peaks are measured at 1350 cm⁻¹ and 1580 cm⁻¹ respectively and are characteristic for carbon materials. The La value is calculated by multiplying the I_{G}/I_{D} ratio by 5.8.

### Spring-Back Value

The spring-back is a source of information regarding the resilience of compacted graphite powders. A defined amount of powder was poured into a die of 20 mm diameter. After inserting the punch and sealing the die, air was evacuated from the die. Compression force of 1.5 metric tons was applied resulting in a pressure of 0.477 t/cm² and the powder height was recorded. This height was recorded again after pressure had been released. Spring-back is the height difference in percent relative to the height under pressure.

### Angle of Repose

The Angle of Repose was measured in accordance with ATMD 6393 (D6393/D6393M-21) using Powder Tester PT-S by Hosowaka. The Carr Angle of Repose is determined by dropping the powder specimen through a vibrating sieve and funnel above a horizontal circular platform and measuring the angle of powder cone in relation to the edge of the circular platform.

Carr Angle of Repose=tan⁻¹[H/R]

where: H=Height of the powder pile in mm and R=Radius of the circular platform in mm.

### Water Contact Angle and Surface Energy

The water contact angle was measured according to the Washburn method (Edward W. Washburn: The Dynamics of Capillary Flow, Phys. Rev., 17, 374, (1921)), using a Kruss force tensiometer K100. In general, the Washburn method monitors the intrusion of a liquid in a porous solid through capillary action over time, which is governed by the Washburn equation.

Graphite particles served as the solid powder material for this measurement, and liquid probe materials included n-heptane (purity>99%) for determining the capillary constant, and water (milliQ grade) as well as diiodomethane (purity>99%) for determining the contact angle.

1.0 gram of graphite powder was used for the measurements. Graphite powder was subjected to a pre-compression step under a load of 500 g for 60 seconds. All measurements were carried at room temperature: 22-25° C. The following parameters were determined:
constant capillary: uptake of n-heptane;
contact angle 1: uptake of water;
contact angle 2: uptake of di-iodomethane.

Calculation of the Surface Free Energy SFE was carried out using an OWRK model and Advance software (from Krüss), expressed as total Surface Free Energy, split into polar and disperse parts.

### Powder Resistivity

1.5 g of graphite particles were compressed inside an insulating die (a ring made of glass fiber reinforced polymer having an inner diameter of 11.3 mm and inserted into a larger ring made of steel for additional mechanical support) between two electrified pistons made of brass (diameter: 1.13 cm). The applied force was controlled during the experiment, while the relative position of the pistons in the die (i.e. the height of the powder sample) was measured using a length gauge. The voltage drop across the sample at known, constant current of 105 mA was measured in situ at different pressure up to 20 kN/cm² using the pistons as the electrodes (2-point resistance measurement).

The sample resistance was calculated using Ohm's law, assuming that the contact resistances between pistons and the sample can be neglected (the calculated resistance was ascribed entirely to the sample). The sample resistivity was calculated using the nominal inner diameter of the mold (1.13 cm) and the measured sample height, and expressed in mΩ*cm. During the experiment, the polymeric ring deformed elastically as a consequence of the lateral expansion (transverse strain) of the sample but can be neglected for comparative purposes. Tabulate values of electrical resistivity are shown for pressures of 10 kN/cm² and 20 kN/cm².

### REFERENCES

Probst, Carbon 40 (2002) 201-205
Grivei, KGK Kautschuk Gummi Kunststoffe 56, Jahrgang, Nr. 9/2003
Spahr, Journal of Power Sources 196 (2011) 3404-3413

### pH Value

1 g of graphite powder is dispersed in 50 mL of distilled water with 2 drops of Imbentin™ and measured by a pH-meter with a calibrated pH electrode.

### Polymer Composition Measurements

### Viscosity (Melt Flow Index)

Melt Flow index (MFI) of the graphite-polymer compound was measured according to ISO 1133. For Example 2, 21.6 kg was used in the measurement and at 230° C. For Example 5, 5 kg was used in the measurement and at 230° C.

### Viscosity (Torque)

The viscosity of the compound in the molten state has been estimated by the torque values automatically generated by an internal mixer (Haake Polylab OS equipped with Rheomix 610) with constant chamber and rotor design by adding a constant volume of the plastic material to be evaluated at a chamber temperature at which the polymer is molten.

### Thermal Conductivity (TC) Tests

Thermal conductivity tests were performed at room temperature using Laserflash (NETZSCH LFA 447) following ASTM E1461. Through-plane measurements have been performed on 10×10×2 mm³ samples cut from the 60×60×2 mm³ bipolar plate. In-plane measurements have been measured by cutting 4 samples 10×3×2 mm³ from the 60×60×2 mm³ and turning them by 90° (on their side) before inserting in the sample holder for laminated samples.

### Electrical Volume Resistivity (VR)

Electrical volume resistivity was measured using the 4-points contact method according to ISO 3915.

### In-Plane VR

Silver paint (normally ethyl acetate-based) is evenly applied to both ends of the specimen. When the paint is dried, crocodile clamps are applied to the part with silver paint to apply an electric current using Schuetz MR1012S. Two wedge-shaped electrodes (distance between the tips of the wedges: 20 mm) are positioned in the middle to measure the voltage drop using Schuetz MR1012S.

The electrical resistivity is calculated according to the formula

$$ρ = R * ( H * W ) / L$$

where ρ is the resistivity in Ω*cm, R is the resistance in Ω, L is the distance between electrodes, H is the thickness of the specimen and W is the width of the specimen.

### Through-Plane VR

The configuration used for this measurement is a planar stack composed of 2 metal plates as current electrodes, 2 sheets of graphite (intermediate layer of contact), the sample sandwiched between the graphite sheets, and 2 thin gold wires (diameter=0.125 mm) as measuring electrodes positioned between the sample and the graphite foils. A pressure of 3 N/mm² is applied to the stack to reduce contact resistances through a press.

Electrical resistance is measured using Schuetz MR1012S and electrical resistivity is calculated according to the formula

$$ρ = R * ( L * W ) / t$$

where ρ is the resistivity in Ω*cm, R is the resistance in Ohms, t is the thickness of the sample, L is the length of the specimen and W is the width of the specimen.

### Area-Specific Electrical Resistivity

Measurement of area specific electrical resistivity have been performed with a four-pole-measuring procedure at a test rig at Zentrum für BrennstoffzellenTechnik GmbH; (https://web.archive.org/web/20221215171732/https://www.zbt.de/nc/en/news/news-anzeige-eng/detail/News/measurement-specification-and-measuring-device-for-electrical-conductance-developed-beppel-project/). Measurements of 60×60×2 mm³ plates take place between two gas diffusion layers that are based on polished and galvanized measuring poles made of copper. For measurement the sample is placed between the two poles, the poles are then pressed on the sample's surface and a preset current is applied. Two voltages are observed during this process: a voltage at the measuring poles (Uges) and a voltage at the measuring tip (Utip). The voltages are saved by software and are needed for calculation of bulk and contact resistance. Measurements are carried out at pressure of 20 bar.

### EXAMPLES

### Example 1

A variety of different coated graphite particulate materials were prepared according to the methods described herein and compared to a variety of known/commercially available coated and uncoated synthetic and natural graphite particulate materials.

For this Example 1, 800 grams of natural shaped graphite were loaded into the vertical electrically heated fluidized bed reactor at ambient temperature. Reactor was heated up to 875° C.-950° C. under constant flow of nitrogen gas in order to fluidize material. Nitrogen or any other inert gas is used in order to avoid oxidation of graphite at temperatures>500° C. Once the temperature is reached hydrocarbon vapors (benzene, toluene) are introduced inside the reactor with the help of nitrogen. In order to reach appropriate amount of coating, amount of the hydrocarbon is controlled. For 2% of the coating (as in IE 2) around 25 g of liquid hydrocarbon is needed. For 4% of coating (as in IE 1 & IE 3) double the amount of hydrocarbon (around 50 g) is needed. Once all of the hydrocarbon is delivered, reactor is purged and cooled down under nitrogen.

Similarly, a rotary kiln can be used for continuous production of coated natural shaped graphite. In such cases, a 2 m long rotary kiln with inclination of 3-4° and rotation of 6-8 rpm is heated to 950° C.-1050° C., with feeding rate of around 2 kg/h of natural graphite (with tap density of around 1 g/cm³) and flow of linear hydrocarbons (methane, acetylene or propane for example) of 2-3 L/min together with 1 L/min of nitrogen.

The coated graphite particulate materials according to the invention (IE 1 to IE 3) were compared to uncoated as well as CVD-coated particulate materials generally known in the art. Invention Examples IE 2 and IE 3 were prepared from the same base graphite material (Comparative Example 5, “CE 5”) with varying amounts of coating (2 wt. % and 4 wt. %).

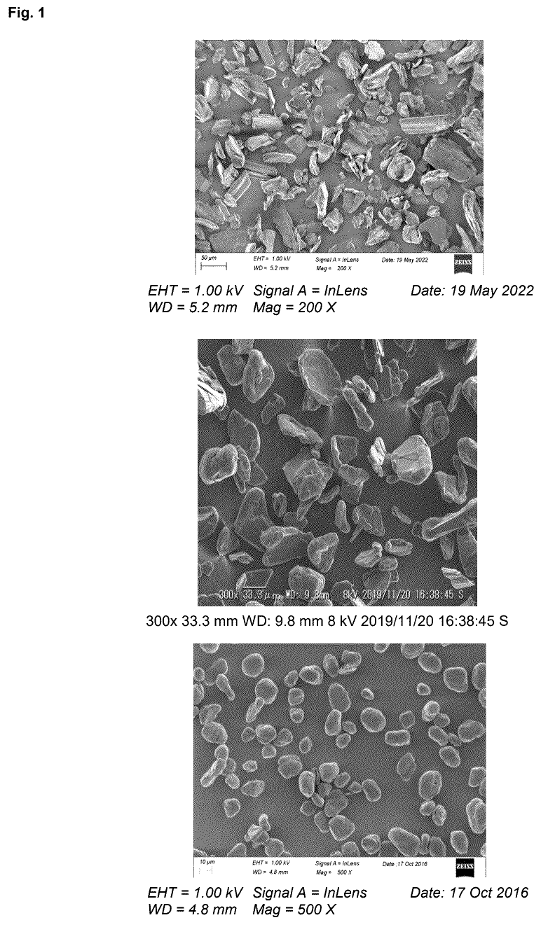

Comparative Example 1 (CE 1) is an uncoated synthetic graphite that has already been used for bipolar plates (e.g. commercial product TIMREX® KS5-75TT by Imerys). It has optimized particle size distribution (with low amount of fine particles (high D₁₀>15 μm) for this application. Comparative Example 2 (CE 2) is a related uncoated potato-shaped synthetic graphite but having a smaller PSD. Comparative Example 3 (CE 3) is an uncoated shaped (spherical) natural graphite (see FIG. 1, middle).

Comparative Example 4 (CE 4 is another uncoated synthetic graphite with a more hydrophilic surface. Comparative Example 5 (CE 5) is an uncoated shaped natural graphite that was used for preparing Invention Examples IE 2 and IE3, as noted above.

Comparative Example 6 (CE 6) is a CVD coated (4 wt. %) version of Comparative Example 1 (CE 1), while Comparative Example 7 (CE 7) is the corresponding CVD coated (4 wt. %) version of Comparative Example 2 (CE 2). Finally, Comparative Example 8 (CE 8) is the corresponding CVD coated (4 wt. %) version (e.g., commercial product GHDR15-4 by Imerys) of Comparative Example 3 (CE 3).

TABLE 2
Physicochemical properties of uncoated graphite particles compared
to coated graphite particulate material according to the invention

| | CE 1 | CE 2 | CE 3 | IE 1 | IE 2 | IE 3 |
|---|---|---|---|---|---|---|
| Graphite | (uncoated) | (uncoated) | (uncoated) | (coated) | (coated) | (coated) |
| CVD coating [wt. %] | — | — | — | 4% | 2% | 4% |
| D₁₀ [μm] | 18 | 5 | 11 | 16 | 22 | 22 |
| D₅₀ [μm] | 41 | 13 | 16 | 24 | 44 | 44 |
| D₉₀ [μm] | 83 | 29 | 23 | 34 | 82 | 82 |
| BET SSA [m²/g] | 4.6 | 8.4 | 6.4 | 3.0 | 2.1 | 1.9 |
| L_{c} [nm] XRD | 178 | 147 | 209 | 256 | 669 | 686 |
| c/2 [nm] XRD | 0.3357 | 0.3357 | 0.3356 | 0.3356 | 0.3355 | 0.3355 |
| I_{D}/I_{G} RAMAN | 0.17 | 0.40 | 0.38 | 0.61 | 0.47 | 0.53 |
| Lₐ [nm] RAMAN | 34.1 | 14.6 | 15.1 | 9.4 | 12.3 | 10.9 |
| Xylene density | 2.233 | 2.243 | 2.237 | n.d. | 2.253 | 2.235 |
| [g/cm³] | | | | | | |
| Tap density [g/cm³] | 0.68 | 0.676 | 1.00 | 1.10 | 1.09 | 1.01 |
| Angle of repose [°] | 47.8 | 53.4 | 45.6 | 31.3 | 35.5 | 34.5 |
| Spring-back (%) | 25 | 18 | 5.4 | 24.0 | 18.4 | 25.6 |
| pH | 5.4 | 4.9 | 4.5 | 6.3 | 5.6 | 5.7 |
| Contact angle | 52.9 | 31.4 | 23.5 | 89.8 | 90.0 | 90.0 |
| (water) [°] | | | | | | |
| Disperse Surface | 30.8 | 28.5 | 25.5 | 31.8 | 22.8 | 27.1 |
| Energy [mJ/m²] | | | | | | |
| Polar Surface | 21.4 | 36 | 40.7 | 2.6 | 4.5 | 3.5 |
| Energy [mJ/m²] | | | | | | |
| Surface Energy | 52.3 | 64.5 | 66.2 | 34.5 | 27.3 | 30.6 |
| [mJ/m²] | | | | | | |
| Powder Resistivity | 10.7 | n.d. | 9.3 | 6.0 | 7.7 | 6.0 |
| [mΩ*cm] | | | | | | |
| @10 kN/cm² | | | | | | |
| Powder Resistivity | 6.8 | n.d. | 6.1 | 4.7 | 4.7 | 4.4 |
| [mΩ*cm] | | | | | | |
| @20 kN/cm² | | | | | | |

| | CE 4 | CE 5 | IE 1 | IE 2 | IE 3 |
|---|---|---|---|---|---|
| Graphite | (uncoated) | (uncoated) | (coated) | (coated) | (coated) |
| CVD coating | — | — | 4% | 2% | 4% |
| D₁₀ [μm] | 6 | 19 | 16 | 22 | 22 |
| D₅₀ [μm] | 14 | 40 | 24 | 44 | 44 |
| D₉₀ [μm] | 29 | 74 | 34 | 82 | 82 |
| BET SSA [m²/g] | 2.7 | 2.9 | 3.0 | 2.1 | 1.9 |
| L_{c} [nm] XRD | 136 | 588 | 256 | 669 | 686 |
| c/2 [nm] XRD | 0.336 | 0.3356 | 0.3356 | 0.3355 | 0.3355 |
| I_{D}/I_{G} RAMAN | n.d. | 0.24 | 0.61 | 0.47 | 0.53 |
| Lₐ [nm] RAMAN | n.d. | 24.4 | 9.4 | 12.3 | 10.9 |
| Xylene density | 2.253 | 2.265 | n.d. | 2.253 | 2.235 |
| [g/cm³] | | | | | |
| Tap density [g/cm³] | 0.926 | 0.91 | 1.1 | 1.09 | 1.01 |
| Angle of repose [°] | | 43.8 | 31.3 | 35.5 | 34.5 |
| Spring-back (%) | 46.5 | 4.6 | 24.0 | 18.4 | 25.6 |
| pH | 5.7 | 5.1 | 6.3 | 5.6 | 5.7 |
| Contact angle | n.d. | 76.9 | 89.8 | 90.0 | 90.0 |
| (water) [°] | | | | | |
| Disperse Surface | n.d. | 35.2 | 31.8 | 22.8 | 27.1 |
| Energy [mJ/m²] | | | | | |
| Polar Surface | n.d. | 6.7 | 2.6 | 4.5 | 3.5 |
| Energy [mJ/m²] | | | | | |
| Surface Energy | n.d. | 41.9 | 34.5 | 27.3 | 30.6 |
| [mJ/m²] | | | | | |
| Powder Resistivity | n.d. | 7.9 | 6.0 | 7.7 | 6.0 |
| [mΩ*cm] | | | | | |
| @10 kN/cm² | | | | | |
| Powder Resistivity | n.d. | 5.0 | 4.7 | 4.7 | 4.4 |
| [mΩ*cm] | | | | | |
| @20 kN/cm² | | | | | |

The exemplary coated graphite particulate materials according to the invention were further compared to comparative coated particulate materials.

TABLE 3
Physicochemical properties of coated graphite particles not according to the invention
compared to coated graphite particulate material according to the invention

| | CE 6 | CE 7 | CE 8 | IE 1 | IE 2 | IE 3 |
|---|---|---|---|---|---|---|
| Graphite | (coated) | (coated) | (coated) | (coated) | (coated) | (coated) |
| CVD coating [wt. %] | 4% | 4% | 4% | 4% | 2% | 4% |
| D₁₀ [μm] | 22 | 5 | 11 | 16 | 22 | 22 |
| D₅₀ [μm] | 47 | 14 | 16 | 24 | 44 | 44 |
| D₉₀ [μm] | 91 | 29 | 23 | 34 | 82 | 82 |
| BET SSA [m²/g] | 2.6 | 5.5 | 4.0 | 3.0 | 2.1 | 1.9 |
| L_{c} [nm] XRD | 173 | 148 | 190 | 256 | 669 | 686 |
| c/2 [nm] XRD | 0.3357 | 0.3358 | 0.3356 | 0.3356 | 0.3355 | 0.3355 |
| I_{D}/I_{G} RAMAN | 0.42 | n.d. | 0.56 | 0.61 | 0.47 | 0.53 |
| Lₐ [nm] RAMAN | 13.8 | n.d. | 10.4 | 9.4 | 12.3 | 10.9 |
| Xylene density | 2.176 | 2.239 | 2.235 | n.d. | 2.253 | 2.235 |
| [g/cm³] | | | | | | |
| Tap density [g/cm³] | 0.79 | 0.714 | 1.0 | 1.1 | 1.09 | 1.01 |
| Angle of repose [°] | 41.3 | 49.9 | 38.2 | 31.3 | 35.5 | 34.5 |
| Spring-back (%) | 46 | 33.6 | 34.3 | 24.0 | 18.4 | 25.6 |
| pH | 5.6 | 5.8 | 5.9 | 6.3 | 5.6 | 5.7 |
| Contact angle | 86.4 | 79.5 | 89.6 | 89.8 | 90.0 | 90.0 |
| (water) [°] | | | | | | |
| Disperse Surface | 49.5 | 41.6 | 32.1 | 31.8 | 22.8 | 27.1 |
| Energy [mJ/m²] | | | | | | |
| Polar Surface | 0.9 | 4.2 | 2.6 | 2.6 | 4.5 | 3.5 |
| Energy [mJ/m²] | | | | | | |
| Surface Energy | 50.5 | 45.8 | 34.7 | 34.5 | 27.3 | 30.6 |
| [mJ/m²] | | | | | | |
| Powder Resistivity | 7.8 | n.d. | 7.3 | 6.0 | 7.7 | 6.0 |
| [mΩ*cm] | | | | | | |
| @10 kN/cm² | | | | | | |
| Powder Resistivity | 5.7 | n.d. | 5.3 | 4.7 | 4.7 | 4.4 |
| [mΩ*cm] | | | | | | |
| @20 kN/cm² | | | | | | |

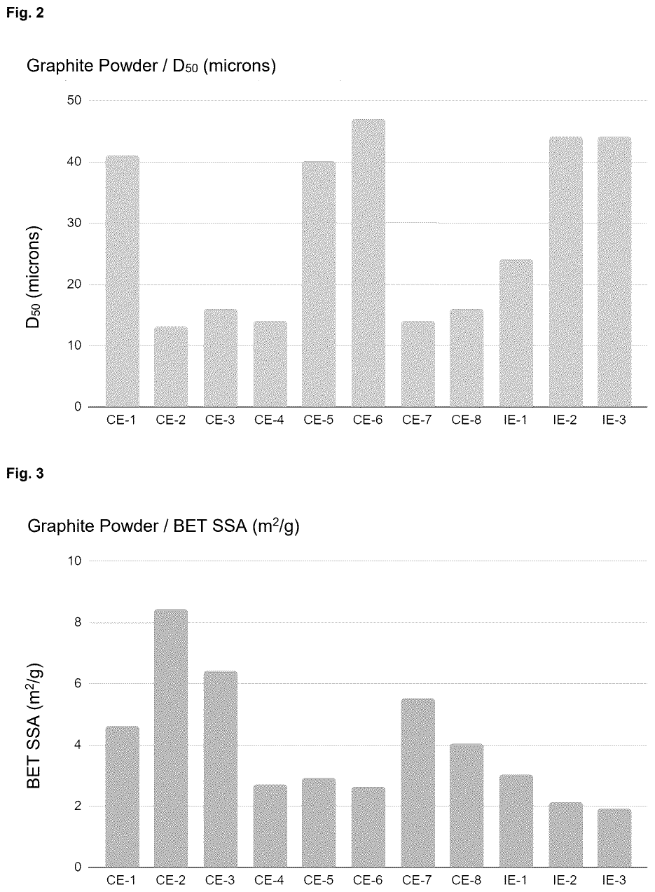

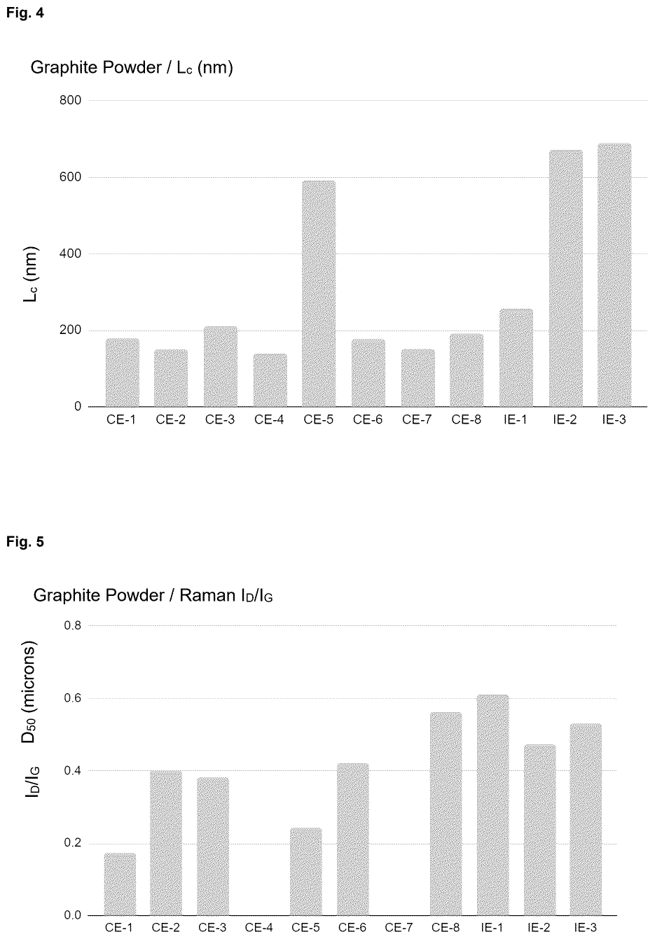

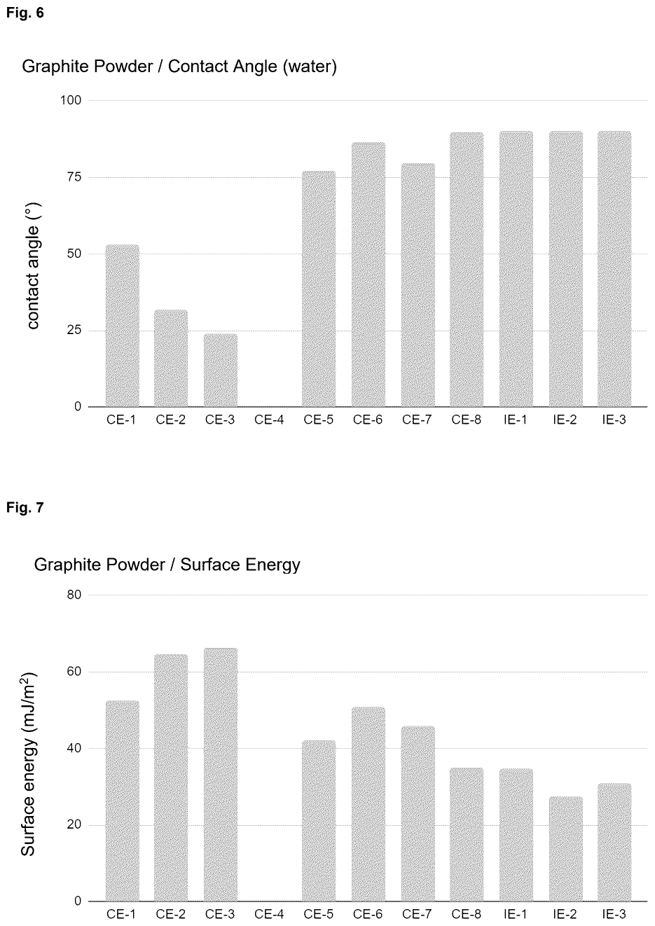

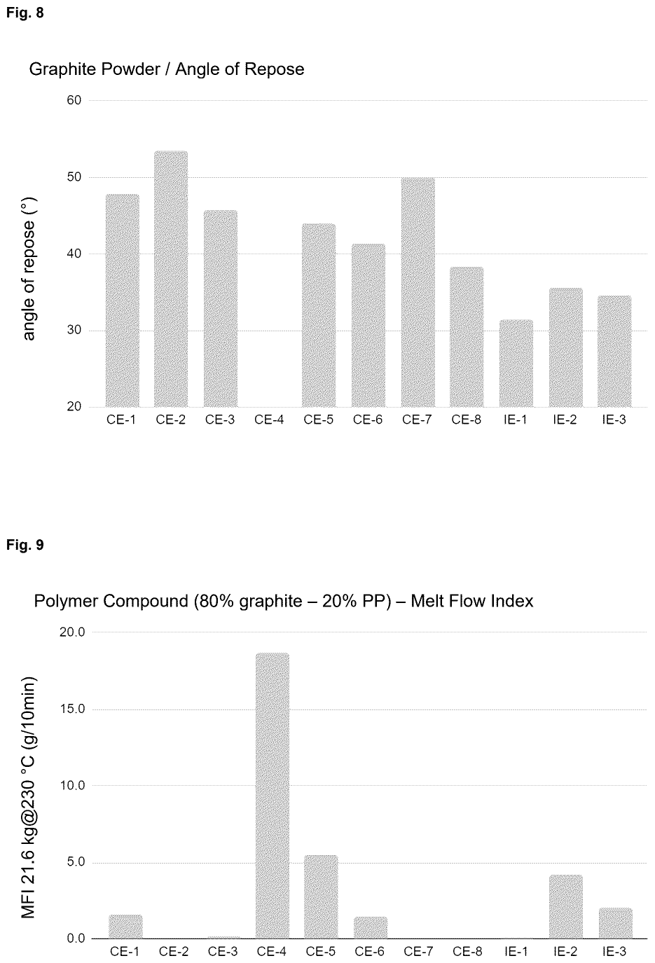

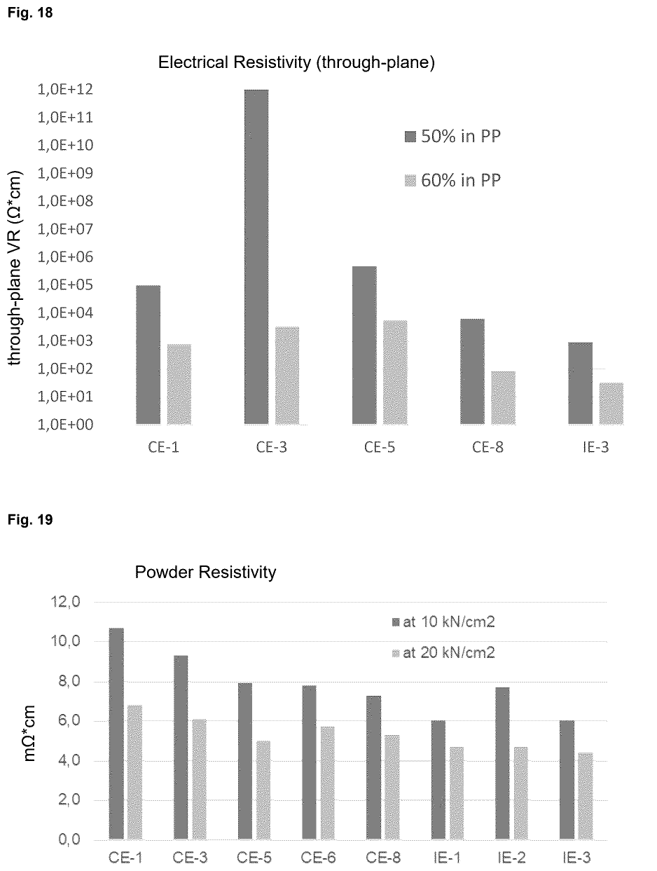

FIGS. 2-8 and FIG. 19 are graphical illustrations of some key parameters from Tables 2 and 3.

### Example 2

Graphite-filled polymer composite materials were prepared with all uncoated and coated graphite particulate materials from Example 1. The respective graphite powder (80 wt. %) was mixed with polypropylene (Moplen HP501L from Lyondell Basell, 20 wt. %) by an internal mixer (HAAKE Rheomix 600 OS) for 5 min at 190° C. at 100 rpm.

Table 4 compares some processability parameters (melt flow index (MFI) and torque values), for the corresponding polymer composite compositions comprising either CE 1 to CE 8 or IE 1 to IE 3.

TABLE 4
Viscosity properties of polymer compositions of graphite particles

| Graphite | | | | | | | | | | | |
|---|---|---|---|---|---|---|---|---|---|---|---|
| powder in | | | | | | | | | | | |
| polymer | CE 1 | CE 2 | CE 3 | CE 4 | CE 5 | | | | | | |
| composition | (uncoated) | (uncoated | (uncoated) | (uncoated) | (uncoated | CE 6 | CE 7 | CE 8 | IE 1 | IE 2 | IE 3 |
| CVD coating | — | — | — | — | — | 4% | 4% | 4% | 4% | 2% | 4% |
| MFI | 1.5 | no | 0.1 | 18.6 | 5.5 | 1.4 | no | no | 0.04 | 4.1 | 2.0 |
| (g/10 min) | | flow | | | | | flow | flow | | | |
| Torque (Nm) | 18.8 | 20.6 | 16.9 | 13.2 | 14.4 | 17.2 | 20.9 | 20.8 | 19.8 | 14.7 | 16.4 |

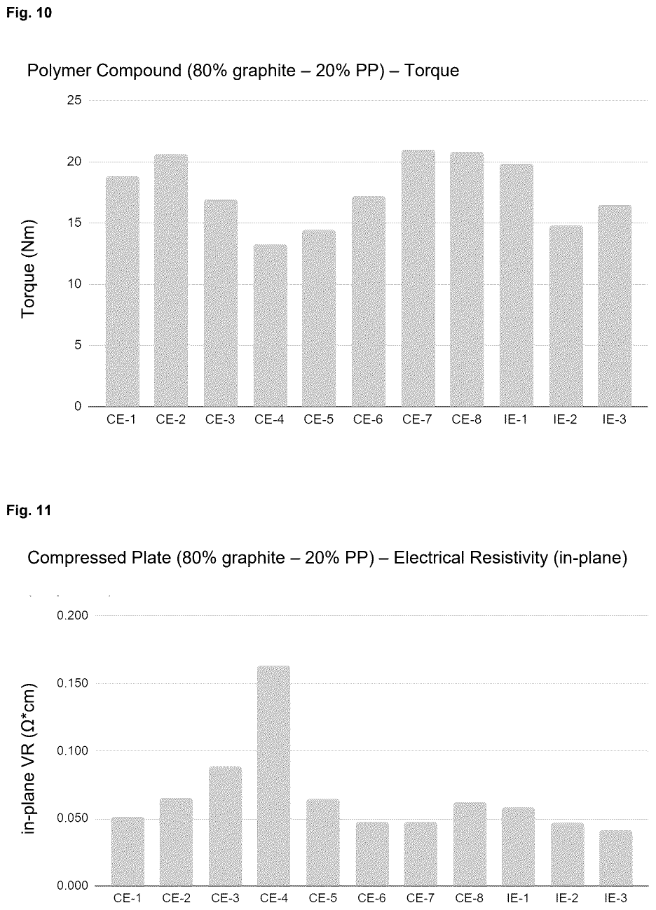

FIG. 9 and FIG. 10 further illustrate the different torque and melt flow indices obtained for selected examples.

### Example 3

All eleven polymer compositions from Example 2 were used to prepare 60×60×2 mm³ plates by compression molding using a LabTech Scientific LP-S-20 press (at 210° C., 70 bar) from which samples of 50×12×2 mm³ (for electrical resistivity measurements) and 10×10×2 mm³ (for thermal conductivity measurements), respectively were cut by water jet.

Table 5 summarizes thermal conductivity and electrical volume resistivity data for the bipolar plates comprising the eleven graphite materials (both in-plane and through-plane). The average thermal conductivity (TC) is calculated as the square root of the in-plane TC multiplied with the through-plane TC. The anisotropy of the thermal conductivity was calculated as in in-plane TC divided by the through-plane TC. In contrast, the anisotropy of the electrical volume resistivity (VR) was calculated as through-plane VR divided by the in-plane VR

TABLE 5
Thermal Conductivity and Electrical Volume Resistivity Data of Bipolar
plates comprising different Graphite Particulate Materials

| Graphite | | | | | | | | | | | |
|---|---|---|---|---|---|---|---|---|---|---|---|
| powder in | | | | | | | | | | | |
| polymer | CE 1 | CE 2 | CE 3 | CE 4 | CE 5 | | | | | | |
| composition | (uncoated) | (uncoated | (uncoated) | (uncoated) | (uncoated) | CE 6 | CE 7 | CE 8 | IE 1 | IE 2 | IE 3 |
| CVD coating | — | — | — | — | — | 4% | 4% | 4% | 4% | 2% | 4% |
| in-plane TC | 34.1 | 25.4 | 26.4 | 12.5 | 45.3 | 33.5 | 26.5 | 13.5 | 12.4 | 36.5 | 31.3 |
| (W/m*K) | | | | | | | | | | | |
| through- | 5.8 | 10.2 | 4.9 | 3.2 | 3.5 | 5.9 | 11.8 | 7.5 | 7.0 | 5.3 | 7.3 |
| plane TC | | | | | | | | | | | |
| (W/m*K) | | | | | | | | | | | |
| average | 14.1 | 16.1 | 11.4 | 6.3 | 12.6 | 14.1 | 17.7 | 10.1 | 9.3 | 13.9 | 15.1 |
| TC (square | | | | | | | | | | | |
| root) | | | | | | | | | | | |
| (W/m*K) | | | | | | | | | | | |
| anisotropy | 5.9 | 2.5 | 5.4 | 3.9 | 12.9 | 5.7 | 2.2 | 1.8 | 1.8 | 6.9 | 4.3 |
| TC | | | | | | | | | | | |
| (calculated) | | | | | | | | | | | |
| in-plane VR | 0.051 | 0.065 | 0.088 | 0.163 | 0.064 | 0.047 | 0.047 | 0.062 | 0.058 | 0.046 | 0.041 |
| (Ω*cm) | | | | | | | | | | | |
| through- | 0.299 | 0.693 | 0.489 | 0.933 | 0.747 | 0.287 | 0.218 | 0.133 | 0.154 | 0.510 | 0.255 |
| plane VR | | | | | | | | | | | |
| (Ω*cm) | | | | | | | | | | | |
| anisotropy | 5.9 | 10.7 | 5.6 | 5.7 | 11.7 | 6.1 | 4.7 | 2.2 | 2.7 | 11.1 | 6.2 |
| VR | | | | | | | | | | | |
| (calculated) | | | | | | | | | | | |

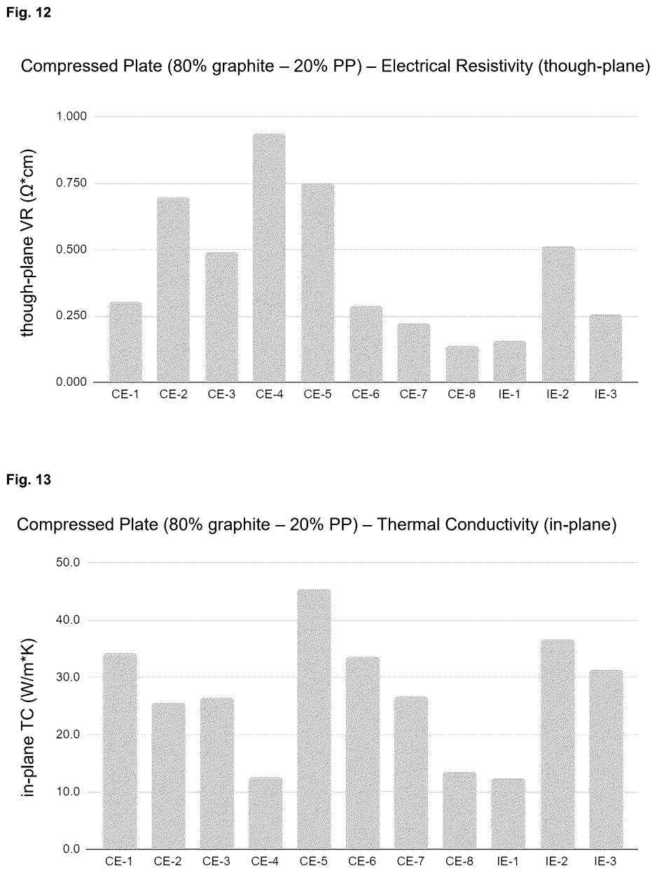

FIGS. 11-14 further illustrate the in-plane and through-plane electrical resistivities and thermal conductivities for selected exemplary bipolar plates at 80 wt. % graphite loading.

### Example 4

For bipolar plates comprising graphite materials CE 5 (uncoated base material for IE 2 and IE3), IE 2 (corresponds to CE 5 with 2 wt. % CVD coating), and IE 3 (corresponds to CE 5 with 4 wt. % CVD coating), areal specific contact and bulk resistance was determined.

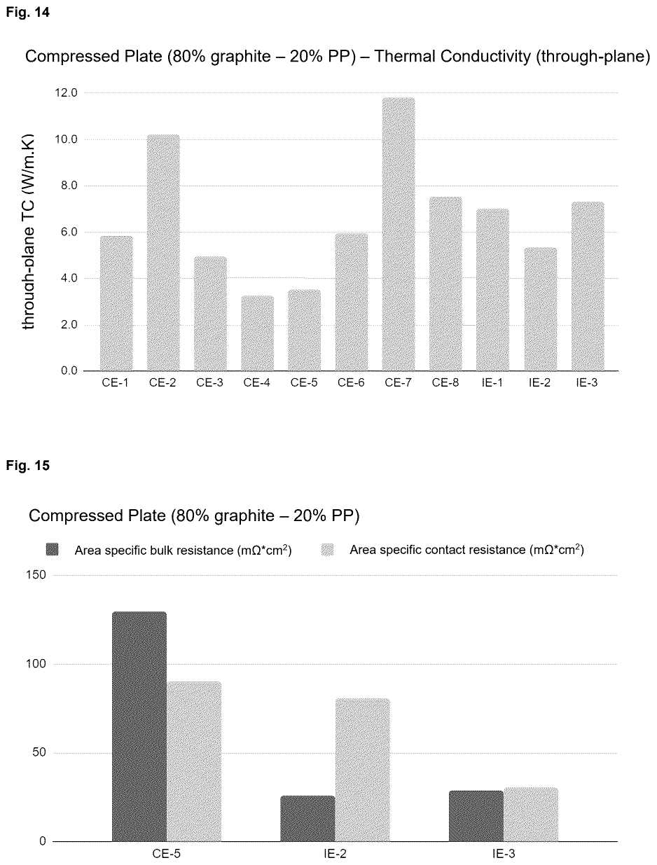

The results are illustrated in FIG. 15. It shows that 2% CVD coating strongly reduces bulk resistivity and 4% CVD coating also further reduces the contact resistance. A lower contact resistance is beneficial as conventional bipolar plates often require post-treatment (e.g. abrasion, plasma, or laser treatment) in order to decrease the contact resistance of the bipolar plates.

### Example 5

Polymer compounds containing either 50 wt. % or 60 wt. % graphite materials CE 1, CE 3, CE 5, CE 8 and IE 3 were prepared by twin-screw extruder Leistritz ZSE 27 mm. The polymer used is PP412MN40 from Sabic, which is a copolymer polypropylene/polyene with a high fluidity, having an MFI of 45 g/10 min (@230° C., 2.16 kg).

The graphite materials were added via a side feeder in the polymer melt. The compounds were extruded at 300 rpm, at 230° C. and a total output of 15 kg/h.

The viscosity (melt flow index) MFI was measured on the compounded samples and performed at 230° C. and 5 kg. Table 6 summarizes the results:

TABLE 6
Viscosity properties of polymer compositions of
graphite particles

| | MFI (5 kg @ 230° C.) (g/10 min) | |
|---|---|---|
| Graphite | 50 wt. % in PP | 60 wt. % in PP |
| CE 1 | 24.64 | 5.3 |
| CE 3 | 40.4 | 10.4 |
| CE 5 | 32.08 | 11.3 |
| CE 8 | 63.47 | 30.1 |
| IE 3 | 48.7 | 26 |

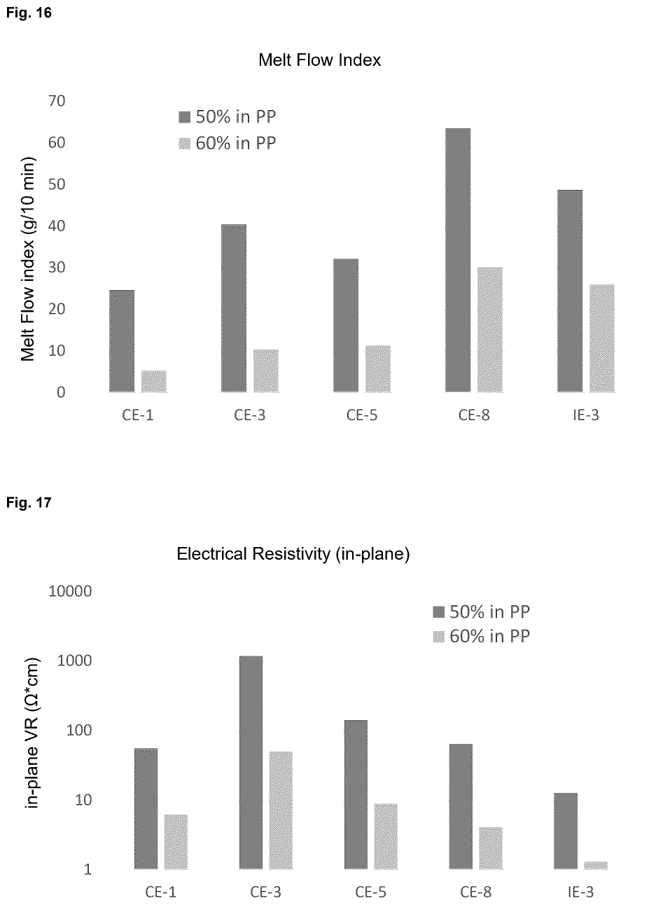

FIG. 16 demonstrates that an increase in graphite particle loading will lead to a higher viscosity and concomitant decrease of the measured melt flow index (MFI), which manifests in a reduced processability. It is also apparent that the decrease is influenced by the nature of the graphite particulate material used.

IE 3 has the high values of MFI (low viscosity) both at 50 wt. % and 60 wt. %, much higher than CE 1, CE 3, CE 5 and comparable to CE 8.

The compounds were injection molded using a Billon Proxima 50T. The material was dried 2-3 hours at 80° C. prior to molding, the molding is carried out on a mold at 230° C. The geometry of the injection molded samples is 60×60×2 mm³ according to ISO D₂, from which samples of 50×12×2 mm³ for electrical resistivity measurements were cut by water jet.

Electrical volume resistivity was measured in two directions: in-plane and through-plane. Table 7 summarizes the results:

TABLE 7
Electrical Volume Resistivity Data of injection molded samples
comprising different Graphite Particulate Materials

| | in-plane VR (Ω * cm) | | through-plane VR (Ω * cm) | |
|---|---|---|---|---|
| | 50 wt. % in | 60 wt. % in | 50 wt. % in | 60 wt. % in |
| Graphite | PP | PP | PP | PP |
| CE 1 | 55.3 | 6.22 | 9.4E+04 | 741.9 |
| CE 3 | 1170 | 50.2 | 1.0E+12 | 3250 |
| CE 5 | 141 | 8.88 | 4.7E+05 | 5477 |
| CE 8 | 63.9 | 4.1 | 6.1E+03 | 80.71 |
| IE 3 | 12.6 | 1.31 | 8.8E+02 | 31.81 |

FIG. 17 and FIG. 18 illustrate the in-plane and through-plane electrical resistivities for selected exemplary bipolar plates with 50 wt. % and 60 wt. % coated graphite particulate material loading in the polymer composition.

IE 3 has the lowest values of electrical volume resistivity both at 50 wt. % and 60 wt. %, and both in-plane and through-plane, much lower than CE 1, CE 3, CE 5 and CE 8.

1. A coated graphite particulate material comprising graphite particles coated with a layer of amorphous carbon, wherein the coated graphite particulate material is characterized by:
(i) a particle size distribution (PSD) with a D₅₀ of at least about 20 μm;
(ii) a BET specific surface area (BET SSA) of less than about 3.0 m²/g;
(iii) a crystallographic L_{c} value of at least about 210 nm; and
(iv) a Raman I_{D}/I_{G} ratio of at least about 0.25.

2. The coated graphite particulate material of claim 1, further characterized by at least one of:
(i) a tap density of at least about 0.7 g/cm³;
(ii) a xylene density of at least about 2.22 g/cm³;
(iii) a crystallographic c/2 value of less than about 0.3360 nm;
(iv) a particle size distribution (PSD) with a D₁₀ of at least about 10 μm; and
(v) a particle size distribution (PSD) with a D₉₀ of at least about 30 μm.

3. The coated graphite particulate material of claim 1, further characterized by at least one of:
(i) a spring back value of less than about 50
(ii) an angle of repose of less than about 40;
(iii) a water contact angle of at least about 70;
(iv) a disperse surface energy of less than about 40 mJ/m²;
(v) a polar surface energy of less than about 10 mJ/m²;
(vi) a total surface free energy of less than about 40 mJ/m²; or
(vi) a powder electrical resistivity of less than about 8 mΩ*cm; and
(vii) a powder electrical resistivity of less than about 6 mΩ*cm;

4. The coated graphite particulate material according to claim 1, wherein the layer of amorphous carbon is present in the coated graphite particulate material in an amount of more than about 1 wt, based on the total weight of the coated graphite particulate material.

5. The coated graphite particulate material according to claim 1, wherein the amorphous carbon is a pyrolytic carbon coating.

6. A method for preparing the coated graphite particulate material of claim 1, comprising
(i) providing a graphite starting material having:
a Raman I_{D}/I_{G} ratio of less than about 0.4;
a crystallographic L_{c} value of at least about 210 nm; and
a particle size distribution (PSD) with a D₅₀ of at least about 20 μm,
a BET SSA of less than about 5 m²/g, and
tap density of at least about 0.6 g/cm³, or of at least about 0.7 g/cm³ or of at least about 0.8 g/cm³ or of at least about 0.9 g/cm³; and
(ii) coating the graphite starting material with a layer of amorphous carbon.

7. The method according to claim 6, wherein the BET SSA of the coated graphite particulate material is lower than the BET SSA of the graphite starting material.

8. The method according to claim 6, wherein the layer of amorphous carbon is deposited by a method selected from:
pitch coating,
atomic layer deposition (ALD),
physical vapor deposition (PVD),
chemical vapor deposition (CVD),
plasma-enhanced chemical vapor deposition (PECVD),
wet coating followed by carbonization,
spray drying followed by carbonization,
hydrothermal carbonization, and
sol-gel.

9. (canceled)

10. A composition comprising the coated graphite particulate material according to claim 1, further comprising
(i) at least one other carbonaceous particulate material selected from the group consisting of natural graphite, synthetic graphite, expanded graphite, carbon fibers, carbon nanotubes, graphene, coke, and carbon black;
wherein the at least one other carbonaceous particulate material is present in an amount from 1 wt. % to 80 wt. %, 1 wt. % to 70 wt. %, 1 wt. % to 60 wt. %, 1 wt. % to 50 wt. %, 1 wt. % to 40 wt. %, 1 wt. % to 30 wt. %, or 1 wt. % to 20 wt. %, based on the total weight of the composition; and
(ii) at least one metal powder selected from the group consisting of titanium, aluminum, silver, nickel, copper, and mixtures thereof, wherein the at least one metal powder is present in an amount of 0.1 wt. % to 10 wt. %.

11. A polymer composite material, comprising the coated graphite particulate material according to claim 1 and a polymer;
wherein
(i) the polymer is present in amount of between 5 wt. % to 55 wt. %, based on the total weight of the polymer composite material;
(ii) the polymer is
a thermoplastic polymer, selected from the group consisting of polypropylene (PP), polyphenyl sulfide (PPS), a fluorinated ethylene propylene (FEP), and polyvinyldifluoride (PVDF),
a thermoset polymer selected from the group consisting of epoxy resins and phenolic resins,
an elastomer selected from the group consisting of synthetic or natural rubbers,
an ethylene octene copolymer,
blends of any of these polymers, or
any of these polymers modified with other polymers; and/or
(iii) the amount of the coated graphite particulate material is between 45 wt. % to 95 wt based on the total weight of the polymer composite material.

12. The polymer composite material according to claim 11, further comprising one or more of the following materials: expanded graphite, natural graphite, synthetic graphite, carbon fibers, carbon nanotubes, graphene, coke, carbon black, and metal powders.

13. A bipolar plate comprising the coated graphite particulate material according to claim 1.

14. An article comprising the bipolar plate according to claim 13,
wherein the article is
(i) a proton-exchange membrane (PEM) fuel cell;
(ii) a redox-flow battery; or
(iii) a proton-exchange membrane (PEM) water electrolyzer.

15. A method for making the bipolar plate according to claim 13, comprising:
(i) mixing a coated graphite particulate material as defined in claim 1 with a polymer to form a polymer composite material,
wherein the mixing is carried out in an extruder; and
(ii) forming a bipolar plate with the polymer composite material obtained in step (i), wherein the bipolar plate is prepared by compression molding, injection molding, extrusion of the polymer composite material obtained in step (i), or a roll-to-roll process.

16. (canceled)

17. (canceled)

18. The coated graphite particulate material according to claim 1 wherein the layer of amorphous carbon is a chemical vapor deposition (CVD) coating.

19. The polymer composite material according to claim 11, further comprising at least one metal powder, wherein the at least one metal powder is present in an amount of 0.1 wt. % to 10 wt. % based on the total weight of the polymer composite material.

20. The polymer composite material according to claim 19, wherein the at least one metal powder comprises titanium, aluminum, silver, nickel, copper, or mixtures thereof.

21. The coated graphite particulate material of claim 2, further characterized by at least one of:
(i) a spring back value of less than about 50%,
(ii) an angle of repose of less than about 40°,
(iii) a water contact angle of at least about 70°,
(iv) a disperse surface energy of less than about 40 mJ/m²;
(v) a polar surface energy of less than about 10 mJ/m²;
(vi) a total surface free energy of less than about 40 mJ/m²; or
(vi) a powder electrical resistivity of less than about 8 mΩ*cm and
(vii) a powder electrical resistivity of less than about 6 mΩ*cm;

22. The coated graphite particulate material according to claim 21 wherein the layer of amorphous carbon is present in the coated graphite particulate material in an amount of between about 1 wt. % and about 10 wt. %, based on the total weight of the coated graphite particulate material.
